(19) United States
(12) Patent Application Publication
(10) Pub. No.: US 2002/0088912 A1
(43) Pub. Date: Jul. 11, 2002

(54) Suspension device for displaying wheel rims

(76) Inventor: Li Chih Yu, Taipei (TW)

Correspondence Address: LI Chih Yu, PO Box 82-144, Taipei, TW

(21) Appl. No.: 09/755,065

(22) Filed: Jan. 8, 2001

(51) Int. Cl. F16B 45/00

(52) U.S. Cl. 248/304

(57) ABSTRACT

A suspension device for displaying wheel rims comprising a seat body mounted onto a wall and a suspension peg being provided on the surface of the seat body, the suspension having a neck portion with an external end connected to an extended head portion, and a suspension element having a base board being provided with a fastening slot having an extended slot portion at the bottom section of the fastening slot correspondingly fastened to the suspension peg of the seat body so as to securely fasten to the seat body, a hooking arm being extended horizontally from the base board and a carrier board being protruded from the base board, thereby the hook section of the suspension device and the carrier board suspend the protruded edge of the top end of the wheel rim, and the suspension device is correspondingly fastened to the seat body so that the wheel rim can be securely mounted to the seat body for displaying.

### BACKGROUND OF THE INVENTION

(a) Field of the Invention

The present invention relates to a suspension device for displaying wheel rims, and in particular, a seat body having a suspension peg being mounted onto a displaying wall such that the suspension element can sidably mounted onto the seat body or to withdraw the suspension element from the seat body.

(b) Description of the Prior Art

The conventional displaying board for wheel rims is normally a framework mounted with a plurality of welded pieces to hold the wheel rims. This type of framework has the following drawbacks:

1) The displaying framework made form a plurality of welded pieces is expensive in manufacturing.

2) This displaying framework occupies a large space.

3) The displaying framework is a fixed type and the arrangement cannot be changed.

4) The displaying effect is not significant, as other welded pieces will affect the entire appearance of the framework.

Therefore it is an object of the present invention to provide a suspension device for displaying wheel rims, which mitigates the above drawbacks.

### SUMMARY OF THE INVETION

Accordingly, it is an object of the present invention to provide a suspension device for displaying wheel rims, wherein the drawback of the conventional structure can be overcome.

Yet another object of the present invention is to provide a suspension device for displaying wheel rims comprising a seat body mounted onto a wall and a suspension peg being provided on the surface of the seat body, the suspension having a neck portion with an external end connected to an extended head portion; and a suspension element having a base board being provided with a fastening slot having an extended slot portion at the bottom section of the fastening slot correspondingly fastened to the suspension peg of the seat body so as to securely fasten to the seat body, a hooking arm being extended horizontally from the base board and a carrier board being protruded from the base board, thereby the hook section of the suspension device and the carrier board suspend the protruded edge of the top end of the wheel rim, and the suspension device is correspondingly fastened to the seat body so that the wheel rim can be securely mounted to the seat body for displaying.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the present invention.

FIG. 2 is a perspective view showing the mounting of a suspension device onto a seat body in accordance with the present invention.

FIG. 3 is a sectional view along line 3-3 of FIG. 2 of the present invention.

FIG. 4 is a perspective view of the suspension device onto a seat body of the present invention.

FIG. 5 is a sectional view along line 5-5 of FIG. 4 of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

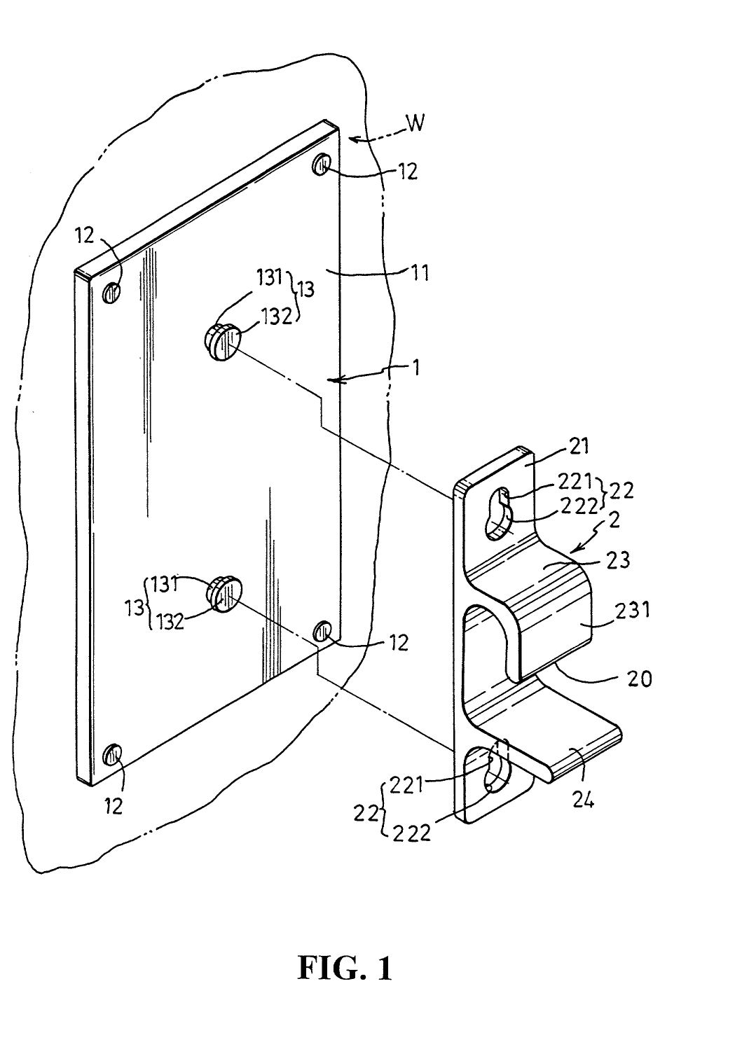

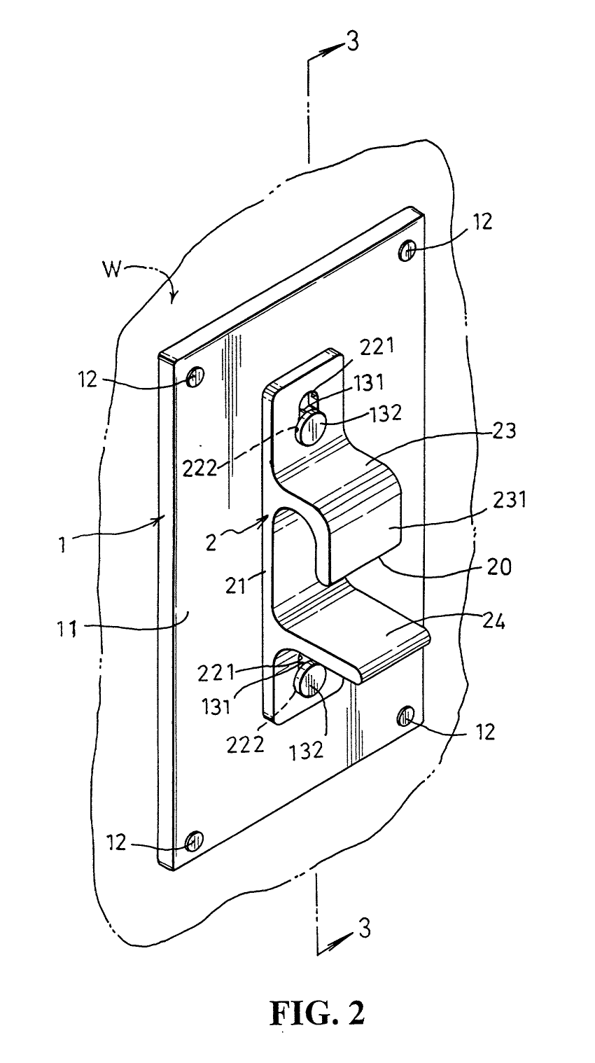

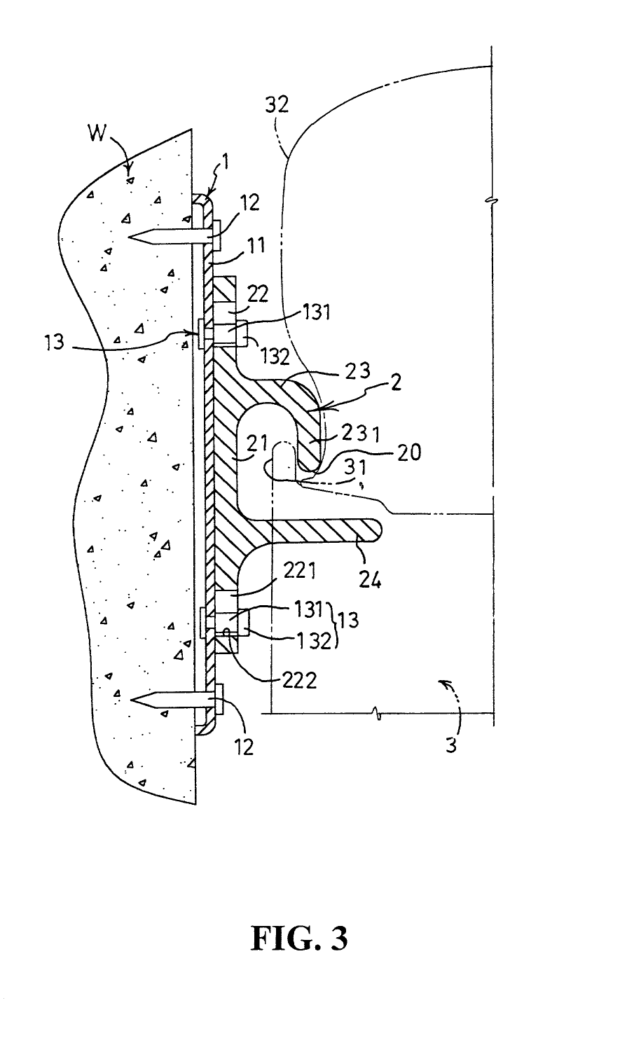

Referring to FIGS. 1 to 5, there is shown a suspension device for displaying wheel rims comprising a seat body 1 and a suspension element 2, wherein the seat body 1 is mounted onto a displaying wall W and at least a suspension peg 13 is provided on the surface of the seat body 1 so as to corresponding connect to the suspension element 2 to display a wheel rim 3. The suspension peg 13 has a neck portion 131 with an external end connected to an extended head portion 132. The suspension element 2 is formed from a one-piece metallic material and has a base board 21 provided with a fastening slot 22 having an extended slot portion at the bottom section of the fastening slot 22 correspondingly fastened to the suspension peg 13 of the seat body 1 so as to securely fasten to the seat body 1. A hooking arm 23 is extended horizontally from the baseboard 21 and a carrier board 24 is protruded from the baseboard 21. The hook section of the suspension device 2 and the carrier board 24 suspend the protruded edge 31 of the top end of the wheel rim 3, and the suspension device 2 is correspondingly fastened to the seat body 1 so that the wheel rim 3 can be securely mounted to the seat body 1 for displaying. In accordance with the present invention, top section of the fastening slot 22 is a connection slot portion 221 and the bottom section of the fastening slot 22 is defined as an extended hole section 222 and the width of the connection slot portion 221 is smaller than the external diameter of the extended head portion 132 of the suspension peg 13 but is larger than the external diameter of the neck portion 131, and the internal diameter of the extended hole section 222 is larger than the external diameter of the extended head portion 132 such that the suspension device 2 is slidably mountable onto the suspension peg 13 of the seat body 1.

In accordance with the present invention, on the board body 11, a plurality of suspension pegs 13 can be mounted so that on one seat body 1 a plurality of suspension device 2 are provided. The suspension peg 13 is not directly mounted onto the displaying wall W and therefore, even there are more than ten suspension pegs on the board body 11, there are only holes at the four corners for the securing pin 12 on the displaying wall W.

In accordance with the present invention, the suspension pegs 13 can be accurately mounted on the preset position on the board body 11 to correspond to the fastening slot 22. Thus, the manufacturing of the present structure is ample and the assembly is convenient.

The suspension device 2 is formed integrally from a steel material, or may be formed by soldering of a steel material.

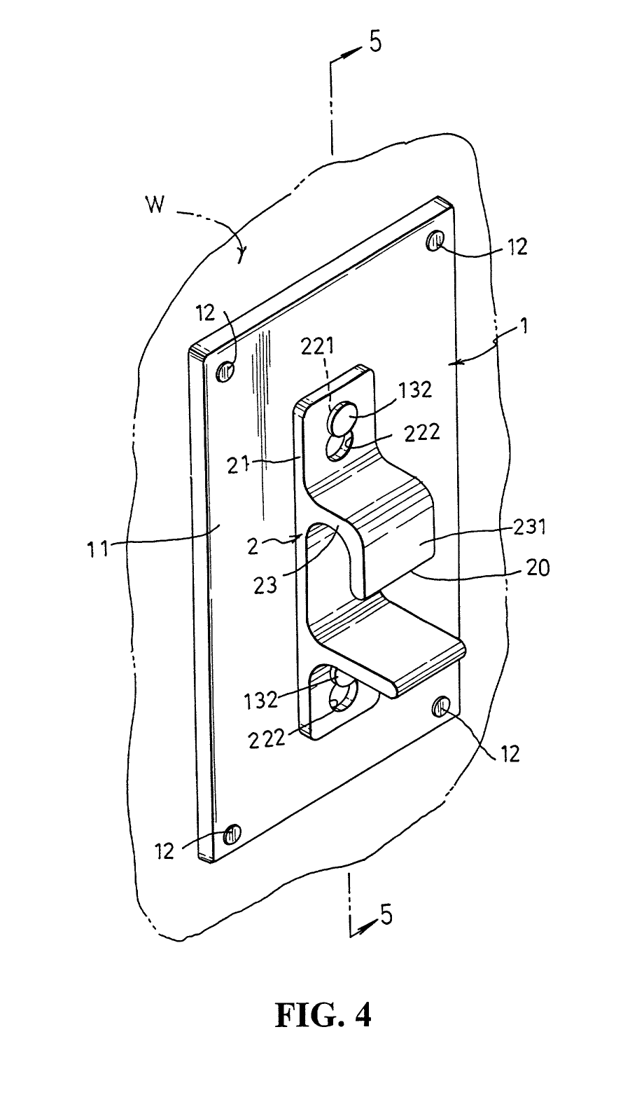

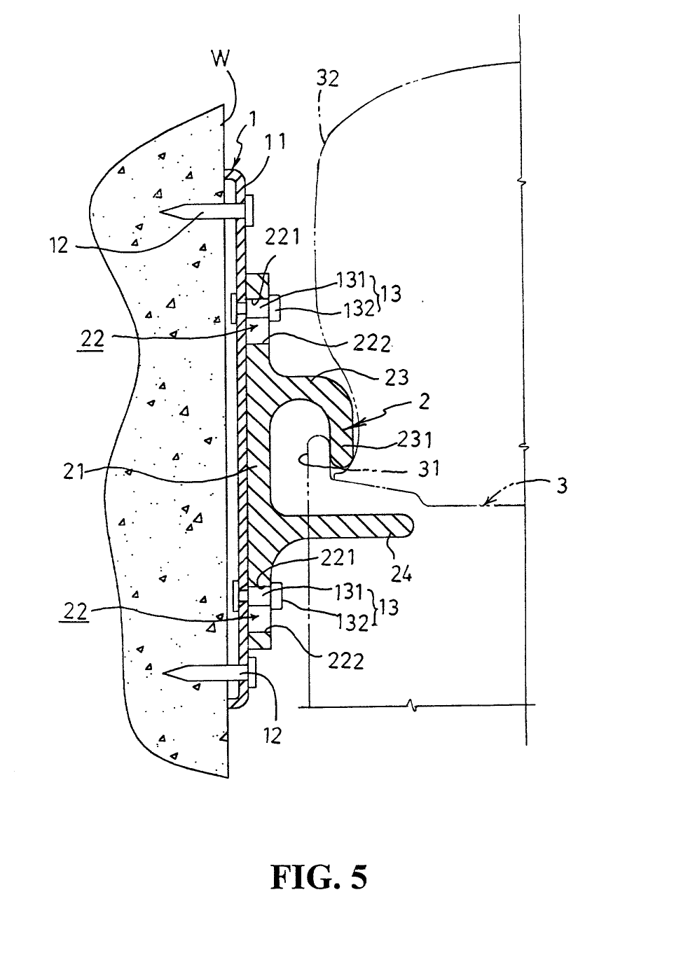

Referring to FIGS. 1 to 3, in application, the securing pins 12 are used to mount the seat body 1 onto a display wall W. The hooking arm 23 of the suspension element 2 and the carrier board 24 hook onto the protruded edge 31 of the wheel rim 3. The wheel rim 3 can be mounted with an external tire 32. The extended hole section 222 of the suspension element 2 is directly corresponding to the extended head portion 132 such that the extended head portion 132 of the suspension peg 13 passes through the external edge of the extended hole section 222, which is shown in FIGS. 4 and 5. The user can slide downward the suspension element 2 such that the neck portion 131 of the suspension peg 13 moves upward along the connection slot section 1221 of the fastening slot 22 such that the extended head portion 132 of the suspension peg 13 is mounted at the external edge of the connection slot portion 221 so as to securely mount the suspension element 2 onto the seat body 1 and to simultaneously display the wheel rim 3 at the displaying wall W.

In accordance with the present invention, the suspension element 2 hooks the protruded edge 31 of the wheel rim, and is then suspended in parallel to the seat body 1. Thus, if the rim 3 is mounted with an external tire 32, the suspension element 2 can be hooked onto the seat body 1.

In accordance with the present invention, the advantages of the present structure are as follows:

(1) The external tire mounted onto the wheel rim can be displayed together with the rim.

(2) The suspension peg can be accurately mounted onto the board body of the seat body to allow easy manufacturing and convenience in assembly.

(3) The suspension element can optionally and rapidly mount onto the seat body as withdraw from the seat body. This allows convenient displaying or changing of displaying arrangement.

(4) One single seat body can hold a plurality of suspension element to maintain the displaying wall in proper condition.

(5) The structure is simple and can be easily mounted.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A suspension device for displaying wheel rims comprising
(a) a seat body mounted onto a wall and a suspension peg being provided on the surface of the seat body, the suspension having a neck portion with an external end connected to an extended head portion; and
(b) a suspension element having a base board being provided with a fastening slot having an extended slot portion at the bottom section of the fastening slot correspondingly fastened to the suspension peg of the seat body so as to securely fasten to the seat body, a hooking arm being extended horizontally from the base board and a carrier board being protruded from the base board, thereby the hook section of the suspension device and the carrier board suspend the protruded edge of the top end of the wheel rim, and the suspension device is correspondingly fastened to the seat body so that the wheel rim can be securely mounted to the seat body for displaying.

2. A suspension device for displaying wheel rims as set forth in claim 1, wherein the seat body comprising a board body is mounted onto a display wall with the suspension peg protruded outwardly.

3. A suspension device for displaying wheel rims as set forth in claim 1, wherein the top section of the fastening slot is a connection slot portion and the bottom section of the fastening slot is defined as an extended hole section, and the width of the connection slot portion is smaller than the external diameter of the extended head portion of the suspension peg but is larger than the external diameter of the neck portion, and the internal diameter of the extended hole section is larger than the external diameter of the extended head portion such that the suspension device is slidably mountable onto the suspension peg of the seat body.
